(19) United States
(12) Patent Application Publication
(10) Pub. No.: US 2002/0108054 A1
(43) Pub. Date: Aug. 8, 2002

(54) Solid-state memory device storing program code and methods for use therewith

(76) Inventors: Christopher S. Moore, San Jose, CA (US); Roger W. March, Santa Clara, CA (US); Daniel T. Brown, Seattle, WA (US)

Correspondence Address: BRINKS HOFER GILSON & LIONE, SUITE 3600, 455 N. CITYFRONT PLAZA DR., CHICAGO, IL, 60611, US

(21) Appl. No.: 09/775,745

(22) Filed: Feb. 2, 2001

(51) Int. Cl. G06F 12/14; H04L 9/00

(52) U.S. Cl. 713/200; 713/189

(57) ABSTRACT

The preferred embodiments described herein provide a solid-state memory device storing program code and methods for use therewith. In one preferred embodiment, a solid-state memory device storing program code is provided that enables a host device to read data from or store data to the solid-state memory device. In another preferred embodiment, a solid-state memory device storing an identifier and encrypted program code is provided. When the solid-state memory device is connected to a host device, the host device decrypts the encrypted program code using the identifier. In another preferred embodiment, program code stored in a solid-state memory device is provided to a host device, and the program code allows the host device to store data only in the solid-state memory device. In another preferred embodiment, a method for distributing program code is provided. In this method, program code is stored in a solid-state memory device comprising a three-dimensional array of memory cells, and the solid-state memory device storing the program code is then distributed.

### BACKGROUND

Modular, portable, non-volatile solid-state memory devices in the form of a memory card or memory stick are available for use with a variety of portable consumer products such as digital cameras and digital audio recorders. The basic memory cell of these memory devices is conventionally designed to provide a relatively-large read current, ensuring relatively-fast read access. To produce these relatively-large read currents, relatively-large switching devices and memory cells are needed, which causes the cost of the memory device to be high. For example, the cost per megabyte as of June 2000 for flash memory cards, such as CompactFlash cards, is between $2-4 at the forty megabyte level (ASP). Because of their high cost, flash memory cards do not offer a cost-effective way for distributing commercial software. Accordingly, conventional solid-state memory devices are used merely to store and transfer data. For example, a memory device can be used in a digital camera. In operation, a user inserts the memory device into the digital camera and takes one or more pictures with the camera. The camera creates a digital representation of the pictures and stores the pictures as digital data in the memory device. The user can then remove the memory device from the digital camera, connect the memory device with a personal computer, and view the stored pictures with an image viewer installed on the computer. Although these modular memory devices are physically compatible with a variety of consumer products, the data stored on a memory device might not be readable by a host device that does not have the program code required to read the data. For instance, if the computer did not have the correct image viewer for the data stored on the memory device, the user would not be able to view the stored pictures.

There is a need for a memory device that overcomes the limitations described above.

### SUMMARY

The present invention is defined by the following claims, and nothing in this section should be taken as a limitation on those claims.

By way of introduction, the preferred embodiments described below provide a solid-state memory device storing program code and methods for use therewith. In one preferred embodiment, a solid-state memory device storing program code is provided. When the solid-state memory device is connected to a host device, the stored program code is provided to the host device. With the program code, the host device can read data from or store data to the solid-state memory device. In another preferred embodiment, a solid-state memory device storing an identifier and program code encrypted using the identifier is provided. When the solid-state memory device is connected to a host device, the encrypted program code and the identifier are provided to the host device. The host device then decrypts the encrypted program code using the identifier. In another preferred embodiment, program code stored in a solid-state memory device is provided to a host device. The program code allows the host device to store data only in the solid-state memory device using the program code. In another preferred embodiment, a method for distributing program code is provided. In this method, program code is stored in a solid-state memory device comprising a three-dimensional array of memory cells. The solid-state memory device storing the program code is then distributed. Other preferred embodiments are provided, and each of the preferred embodiments described herein can be used alone or in combination with one another.

The preferred embodiments will now be described with reference to the attached drawings.

### BRIEF DESCRIPTION OF THE DRAWINGS

FIG. 1 is an illustration of a solid-state memory device and a host device of a preferred embodiment.

FIG. 2 is an illustration of a solid-state memory device of a preferred embodiment that stores program code written in a hardware-independent language and host devices of a preferred embodiment having different hardware platforms and a program code interpreter.

FIG. 3 is a flow chart of a method of a preferred embodiment for storing encrypted program code in a memory device.

FIG. 4 is an illustration of a memory device and a data storage device of a preferred embodiment that illustrate the use of the method shown in FIG. 3.

FIG. 5 is a flow chart of a method of a preferred embodiment for using encrypted program code stored in a memory device.

FIG. 6 is an illustration of a memory device and a host device of a preferred embodiment that illustrate the use of the method shown in FIG. 5.

### DETAILED DESCRIPTION OF THE PRESENTLY

Preferred Embodiments

The preferred embodiments described below are illustrated using a host device and a memory device. As used herein, the term “host device” is intended to refer to any device that can be provided with a memory device and can be used to read data from the memory device. A host device can take any suitable form including, but not limited to, a digital camera, a digital audio player, an electronic book, a personal digital assistant, a game player, a mobile telephone, a general-purpose programmable computer (e.g., a personal computer (PC)), a printer, and a projector. “Data” is intended to broadly refer to any type of digital data that can be processed or manipulated by program code running on a host device. As used herein, the term “program code” refers to digital information that is executed or run by a host device and that can be used to process or manipulate data. Examples of data include, but are not limited to, still pictures (photographs), music, audio in general, books, text in general, maps, sequences of images, and video in general. Also as used herein, the term “data storage device” is intended to refer to any device that can store data onto a memory device and can take the same forms as those listed above with respect to a host device (e.g., a digital camera).

The term “memory device” broadly refers to any suitable storage medium for storing digital data or program code. In the preferred embodiments described below, the memory device takes the form of a solid-state memory device, such as those having two-dimensional or three-dimensional memory arrays. As used herein, the term “solid-state memory device” refers to a memory device with an array that responds to electrical write signals to cause digital information to be stored in the memory array and/or to electrical read signals to cause digital information to be read from the memory array. In one preferred embodiment, the solid-state memory device takes the form of a modular, handheld unit (such as a card or a stick) that is readily connected with and removable from a host device. As used herein, the term “connected with” means directly connected with or indirectly connected with through one or more named or unnamed components. In such an embodiment, the memory device and the host device can each comprise respective exposed electrical connectors, and the memory device is provided to the host device by connecting the exposed electrical connector of the memory device with a mating exposed electrical connector of the host device. In this way, the memory device can be readily inserted into and removed from the host device and replaced with another memory device. The memory device can include a housing, such as a plastic or metal housing, that encloses the memory array and mounts the electrical connector in an exposed portion of the memory device.

These preferred embodiments can be used with any suitable solid-state memory device, for example, solid-state memory devices having a two-dimensional or three-dimensional memory array. Three-dimensional memory arrays provide important economies in terms of reduced size of the memory array and associated reductions in manufacturing cost. U.S. Pat. No. 5,835,396 to Zhang, U.S. Pat. No. 6,034,882 to Johnson, U.S. patent application Ser. No. 09/560,626 to Knall, and U.S. patent application Ser. No. 09/638,428 to Johnson may be taken as examples of three-dimensional memory arrays. Each of these patent documents is hereby incorporated by reference. Further details regarding alternative structures are presented in U.S. patent applications Ser. Nos. 09/638,427 and 09/638,334, both of which are assigned to the assignee of the present application and are hereby incorporated by reference. In one preferred embodiment, the memory cells are arranged in a plurality of vertically-stacked layers of memory cells, with each memory cell comprises exactly two terminals. Each memory cell is connected to exactly two wires (a wordline wire and a bitline wire), and the memory cells are made from a semiconductor material. In one preferred embodiment, the memory cells are write-once.

Three-dimensional memory arrays of the type that include multiple vertically-stacked layers of memory cells use very small switching devices, providing a small memory cell, a small total chip area, and low cost. Because of the low cost associated with three-dimensional memory arrays, these memory devices can be used for applications that are cost prohibitive with conventional two-dimensional solid-state memory devices. One such application is the distribution of program code. As described above, because conventional two-dimensional solid-state memory devices use large switching devices and large memory cells, these solid-state memory devices are too expensive to store program code for distribution. Accordingly, program code is sold to a user on an inexpensive non-solid-state device, such as a CD-ROM, and the expensive solid-state memory devices are sold merely as data storage devices for these applications. Because of the low cost associated with three-dimensional solid-state memory devices, program code can be distributed on solid-state memory devices. For example, a commercial software manufacturer can store program code (e.g., a word processing program) on three-dimensional solid-state memory devices and distribute (e.g. sell or distribute for free) these devices to a user (e.g., an end consumer, a distributor, or retail store).

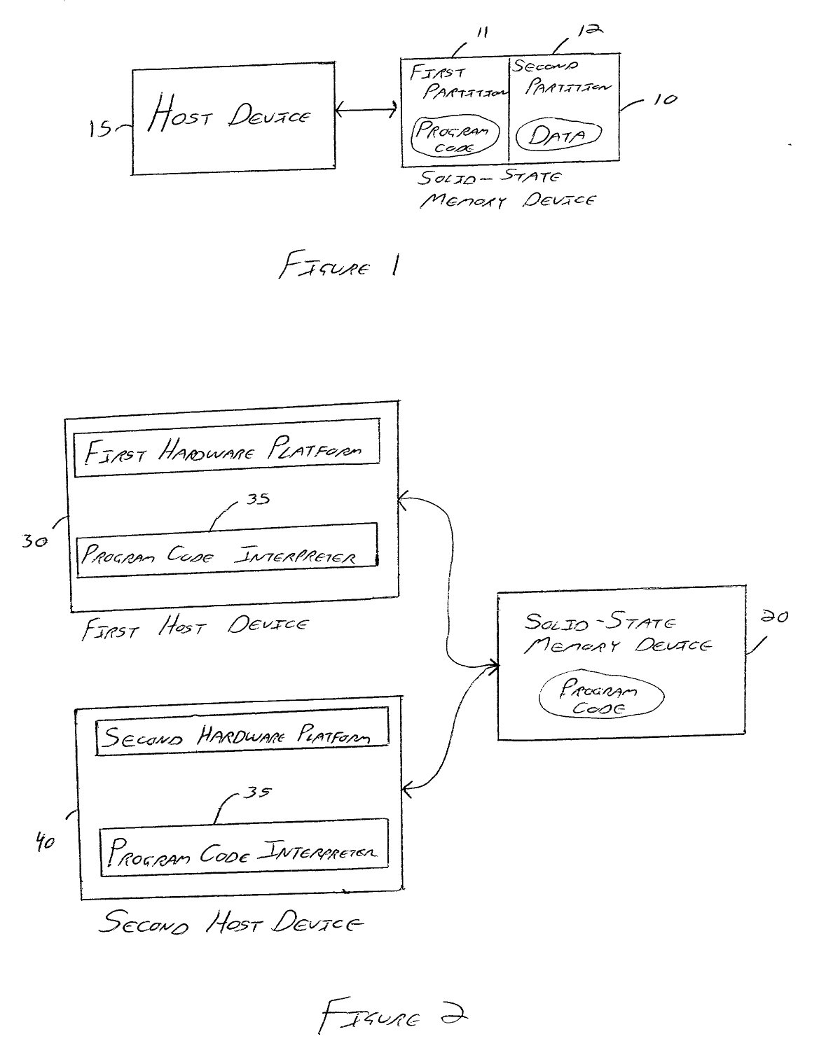

Turning now to the drawings, FIG. 1 is an illustration of a memory device 10 and a host device 15 of a preferred embodiment. The memory device 10 takes the form of a solid-state memory device that comprises a first partition 11 storing program code and a second partition 12 storing data. It should be noted that while two partitions 11, 12 are shown in FIG. 1, the solid-state memory device 10 can comprise additional partitions. Further, the program code and the data can be stored in different portions in a single partition. The program code in the first partition 11 is operative to read the data stored in the second partition 12 and/or store data in the second partition 12. In this way, the program code is “tied” to the data read from or stored in the second partition 12. To read the stored data, the solid-state memory device 10 is connected with the host device 15, and the program code stored in the first partition 11 is provided to the host device 15. In one preferred embodiment, the program code is automatically provided to the host device 15 when the solid-state memory device 10 is connected with the host device 15. In this way, the loading of the program code onto the host device 15 is invisible to the user. For example, if the solid-state memory device 10 is configured with the DOS FAT file system, the solid-state memory device 10 can store an autorun.inf file that would cause the host device 15 to automatically execute the program code once the solid-state memory device 10 is connected with the host device 15. After the program code is provided to the host device 15, the host device 15 can read the stored data or write data to the memory device 10 using the program code.

To illustrate the operation of this preferred embodiment, consider the situation in which a user uses the solid-state memory device 10 in a digital camera. Pictures taken by the digital camera are saved as digital data in the second partition 12 of the solid-state memory device 10, and the program code stored in the first partition 11 takes the form of an image viewer for viewing the stored pictures. The digital camera can store the image viewer in the solid-state memory device 10, for example, when a user first inserts the solid-state memory device 10, after one or more pictures are stored, or before the user removes the solid-state memory device 10. Alternatively, the image viewer can be stored by a manufacturer of the solid-state memory device 10 as part of the memory device. The digital camera can use its own program code to store the digital pictures on the solid-state memory device 10, or it can use the program code stored on the solid-state memory device 10.

After the digital pictures are stored, the user removes the solid-state memory device 10 and connects it to the host device 15, which is a personal computer in this example, to display the stored pictures. When the solid-state memory device 10 is connected to the computer, the image viewer is automatically loaded onto the computer. Alternatively, the image viewer can be manually loaded from the solid-state memory device 10. Because the image viewer required to view the stored pictures is stored on the same memory device that stores the pictures, the image viewer and the pictures are tied together, allowing the pictures to be viewed on any host device merely by connecting the solid-state memory device 10 with the host device 15. Accordingly, a host device does not need to be pre-configured with the image viewer nor is a second memory device required to install the image viewer onto the host device 15. Thus, unlike conventional memory devices that merely store data, the memory device of this preferred embodiment also stores program code to facilitate the reading of the stored data by a host device. This is especially important for users who are interested only in viewing the stored pictures and do not want to be bothered with locating and installing the application needed to view the pictures. This makes the solid-state memory device 10 “self-sufficient” and greatly enhances its portability.

As another example, consider the situation in which a user wishes to give a presentation using an overhead projector. In the past, a user would use a presentation program to create the overheads, handouts, and speaker notes for the presentation. To deliver the presentation at a remote location, the user would transport his computer and the necessary cabling to the remote location, connect his computer with the overhead projector, and configure the presentation program and overhead projector. Not only can transporting the computer to the remote location be burdensome, but connecting and configuring the equipment can be time-consuming and difficult, especially for casual computer users. These difficulties are avoided by using this preferred embodiment. With this preferred embodiment, the user would insert a memory device storing the presentation program into his computer, create the presentation, and store the presentation on the memory device. The user would then simply disconnect the memory device from his computer, transport the memory device (not his computer) to the remote location, and insert the memory device into the projector. The projector would load the presentation program stored on the memory device, and the user would open the stored presentation.

Different versions of program code can be stored on the memory device to increase its portability. For instance, in the above example, two versions of the presentation program can be stored—one readable by the personal computer and the other readable by the projector. Further different versions of the program code can also be stored that are designed for different host devices. For instance, in the above example, the presentation program stored for the computer can have more advanced editing capabilities than the presentation program stored for the projector, which may have more advanced display functions.

While the preferred embodiments described above can enhance the portability of a memory device, a problem can be encountered if the host device uses a file system that is different from the file system used to store the program code or the data in the memory device. For example, a host device configured with a DOS FAT file system may not be able to read a memory device operating with a write-once file system, such as the one described in U.S. patent application Ser. No. 09/748,589, which is assigned to the assignee of the present invention and is hereby incorporated by reference. To avoid this difficulty, it is preferred that the memory device comprise a portion that is readable by the file system of the host device and that stores program code operative to enable the host device to read the portion of the memory device storing program code or data, as described in U.S. patent application serial number ______ (Attorney Docket No. 10519/17; MD-44), which is assigned to the assignee of the present invention and is hereby incorporated by reference.

As noted above, the program code can take any suitable form. For example, the program code can be an application, such as, but not limited to, an image viewer, an audio player, a calendaring tool, a word processor, a game, or a presentation program. The program code can also be an extension to an application already installed on the host device or a driver, such as a print instruction file. In some embodiments, the first partition 11 of the memory device 10 storing the program code is fixed, while the second partition 12 is updateable. For example, when the program code takes the form of a word processor, the first partition 11 can be fixed to prevent a user from inadvertently writing over the word processor, and the second partition 12 can be updateable to allow the user to save documents created with the word processor in the second partition 12. As another example, when the program code takes the form of a game, the second portion 12 can be updateable to store high scores or saved games. The first partition 11 and/or the second partition 12 can be fixed or updateable.

The program code can be written in any suitable programming language. If the program code is written in a hardware-specific language, the program code can only be executed on host devices with a specific hardware platform. If the program code is written in a hardware-independent language, however, the program code can be executed on any host device having an interpreter for translating the program code into machine code understandable by the hardware platform of the host device. Accordingly, program code written in a hardware-independent language increases the portability of the memory device, which may be particularly desired in transporting data across different types of consumer devices (e.g., digital cameras, personal digital assistants (PDAs), projectors, etc.) One suitable hardware-independent language is Java. The source code of a Java program is compiled into an intermediate language called “bytecode.” Bytecode is compiled for a theoretical machine, and a Java interpreter (a Java Virtual Machine) in a host device emulates that machine by converting the bytecode into machine code at runtime. Because bytecode is not dependent on any specific hardware platform, it will run in any host device with the Java interpreter.

The following example illustrates the use of hardware-independent program code and will be discussed in conjunction with FIG. 2. FIG. 2 shows a solid-state memory device 20 and two host devices: a first host device 30 using a first hardware platform and a second host device 40 using a second hardware platform. Both the first and second host devices 30, 40 comprise a program code interpreter 35. In this example, the first host device 30 takes the form of a personal computer with an Intel Pentium processor using the Windows operating system, the second host device 40 takes the form of an overhead projector with a customized hardware platform, and the program code interpreter 35 takes the form of a Java interpreter. The program code stored in the solid-state memory device 20 is a presentation program written in Java. In this example, the user desires to create a presentation on his personal computer 30 and deliver the presentation using the overhead projector. The user first connects the solid-state memory device 20 with his personal computer 30. The Java interpreter 35 converts the Java-version of the presentation program into machine code appropriate for the computer's hardware platform, and the code is executed. After the user generates his presentation with the presentation program, he saves the presentation on the solid-state memory device 20. The user then removes the solid-state memory device 20 and plugs it into the overhead projector 40. The Java interpreter 35 of the overhead projector 40 converts the Java-version of the presentation program into machine code for the projector 40, and the presentation program is executed on the projector 40. If an audience member asks for a copy of the slides used in the presentation, the user can plug the solid-state memory device 20 into the Java-capable printer, and print the desired slides. As the preceding example illustrates, by using a hardware-independent language, program code stored on a solid-state memory device can be read across multiple platforms with virtually no effort by a user.

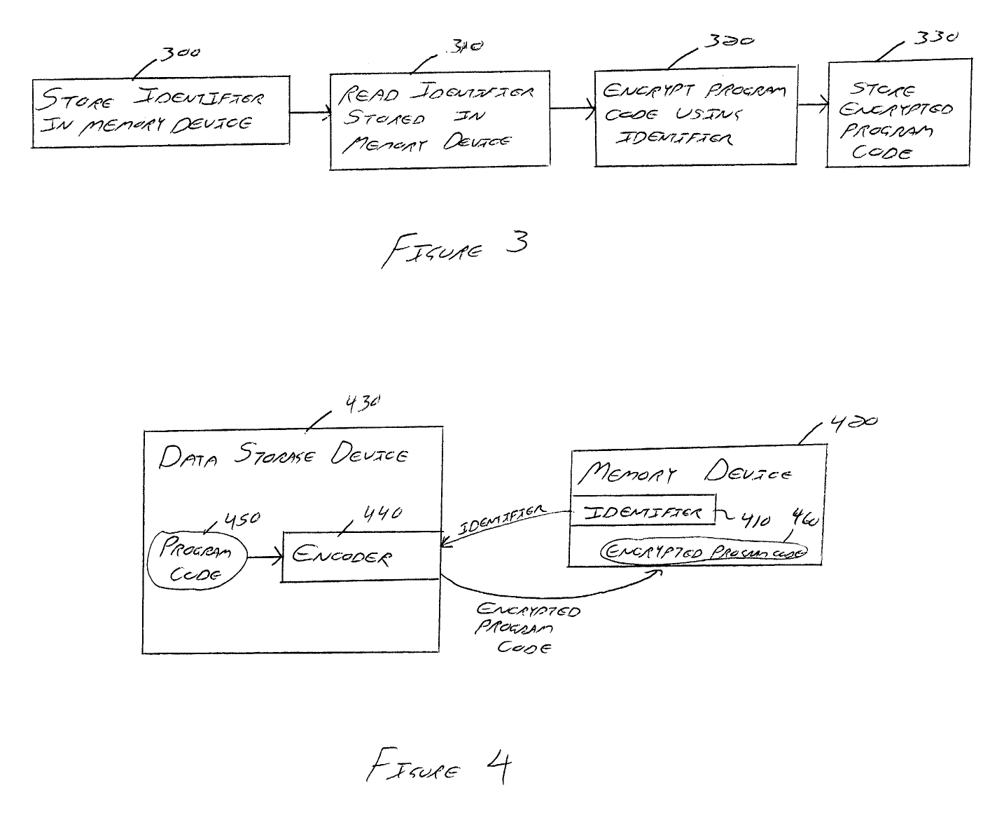

Several techniques can be used to prevent unauthorized use or copying of program code stored in a solid-state memory device. In one technique, the memory device is provided with a unique identifier, which is used to encrypt program code stored in the memory device. In this way, the program code can only be used by a host device if the identifier of the memory device that provides the program code to the host device is the same as the identifier used in the encryption process. This technique will be described in with reference to FIGS. 3-6. FIG. 3 is a flow chart of a preferred embodiment for storing encrypted program code in a memory device and will be described in conjunction with FIG. 4. First, an identifier 410 is stored in a memory device 420 (act 300). In one embodiment, the identifier 410 is created and stored during the manufacturing process of the memory device 420, while in another embodiment, the identifier 410 is created and stored by a data storage device storing program code in the memory device. The identifier 410 can be data (e.g., a 128-bit random number) or an electronic, mechanical, or optical feature of the memory device 420. In one embodiment, the identifier 410 is unique to the memory device, while in another embodiment, the identifier 410 is unique to a group of memory devices. Next, a data storage device 430 reads the identifier 410 of the memory device 420 (act 310). Using an encoder 440, the data storage device 430 encrypts program code 450 using the identifier 410 as a private key (act 320). Any suitable encryption technique can be used. The encrypted program code 460 is then stored in the memory device 420 (act 330).

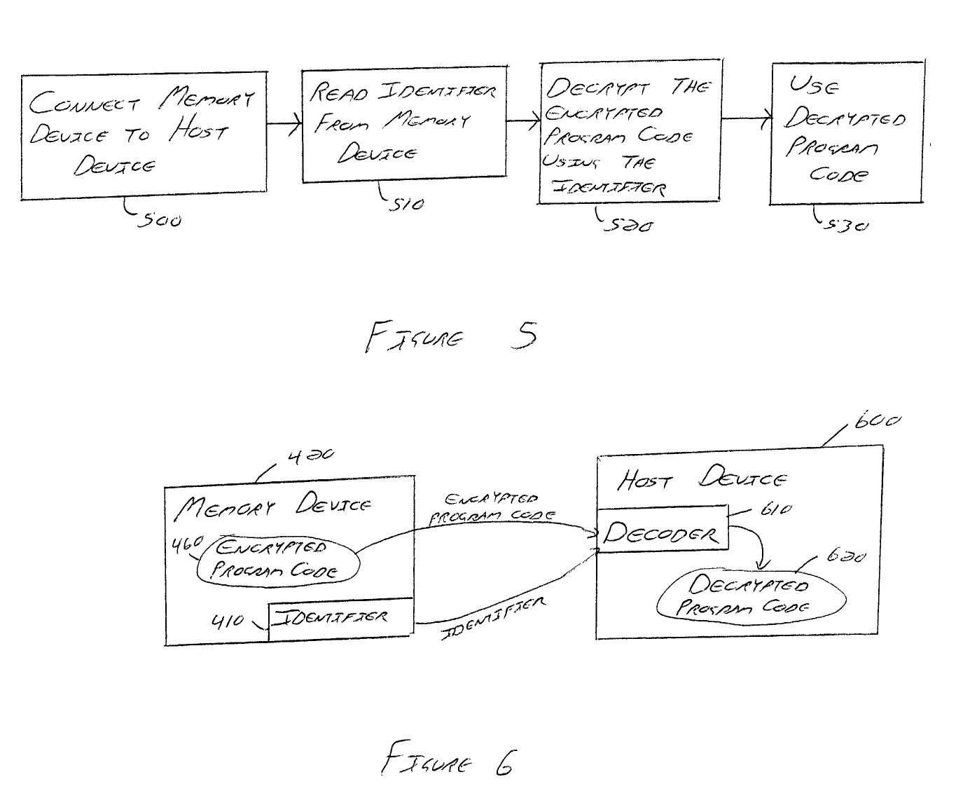

FIG. 5 is a flow chart of a preferred embodiment for using the encrypted program code with a host device and will be described in conjunction with FIG. 6. First, the memory device 420 is connected to a host device 600 (act 500). The host device 600 detects the memory device 420 and sees that the encrypted program code 460. A decoder 610 in the host device 600 then reads the identifier 410 from the memory device 420 (act 510) and decrypts the encrypted program code 460 using the identifier 410 (act 520). The decrypted program code 620 is then used by the host device 600 (act 530).

This technique can be used to prevent unauthorized copying of prerecorded encrypted program code. Consider, for example, a software manufacturer who distributes software on memory devices. Each software application could be encrypted with the identifier of the memory device storing the software (the original memory device). After a user buys the memory device, he can connect the original memory device with any host device, and the identifier of the original memory device will be used to decrypt the encrypted software application. If the user copies the software application onto another memory device (a target memory device), the software application will not be usable if the identifier of the target memory device is different from the identifier of the original memory device. If the identifier is stored as data in the memory device, a user may attempt to alter the identifier of the target memory device to that of the original memory device. The likelihood of success of this attempt decreases if the target memory device is a write-once memory device since it would be difficult or impossible to alter the stored identifier. The likelihood of success is further reduced if error checking and correction (ECC) bits are tied to the identifier. In this way, even if the identifier of the target memory device were altered to that of the original memory device, the ECC bits would not correspond to the altered identifier. Accordingly, an ECC mismatch can detect alteration of a memory device's stored identifier. Further details concerning ECC can be found in the following two U.S. patent applications, which are assigned to the assignee of the present invention and are hereby incorporated by reference: U.S. patent application Ser. No. 09/748,589 and U.S. patent application Ser. No. 09/747,574.

Another technique for preventing unauthorized use of the program code stored in a memory device is to limit the use of the program code to a predetermined amount of time or a predetermined number of uses. For example, a software application can be distributed on a memory device and be used for a trial period (e.g., 30 days or 10 uses). At the end of the trial period, the software application will not be allowed to execute. The user can be given the option of extending the usability of the software application. For example, if the user pays an additional license fee to the manufacturer of the software application, the manufacturer can provide the user with a code that will permanently enable the software application or enable the software application for an additional predetermined time or number of uses.

In another technique, the program code is allowed to store data only in the memory device that stores the program code. This can be accomplished, for example, by allowing the host device to store data only in the drive that contains the memory device. The user can be given the option of enabling the program code to store data in other memory devices or in other portions of the memory device, for example, if user pays an additional license fee to the manufacturer of the software application. If the memory takes the form of a write-once memory device, the amount of data that can be stored in the memory device is limited, thereby effectively limiting the use of the program code. For example, if the program code takes the form of a word processor that can only store data in the same write-once memory device that stores word processor program code, the user will only be able to save a limited number of documents generated by the word processor. After the memory device has been filled, the user can contact the manufacturer of the word processor to obtain a license to store data generated by the word processor in another memory device. Alternatively, the user can purchase a new memory device storing a new word processor and having available storage space. This alternative may be economically feasible if a low-cost memory device is used, such as a memory device having a three-dimensional array of memory cells, as described above.

It is intended that the foregoing detailed description be understood as an illustration of selected forms that the invention can take and not as a definition of the invention. It is only the following claims, including all equivalents, that are intended to define the scope of this invention. Further, any aspect of any of the preferred embodiments described herein can be used alone or in combination with one another.

What is claimed is:

1. A method for using a solid-state memory device storing program code, the method comprising:
(a) connecting a solid-state memory device with a host device, the solid-state memory device storing program code;
(b) providing the program code to the host device; and
(c) with the host device, performing at least one of the following acts:
(c1) reading data stored in the solid-state memory device using the program code;
(c2) storing data in the solid-state memory device using the program code.

2. The invention of claim 1, wherein (b) comprises automatically providing the program code to the host device.

3. The invention of claim 1, wherein (c) comprises, with the host device, storing data in the solid-state memory device using the program code.

4. The invention of claim 1 further comprising, before act (a), providing the solid-state memory device to a data storage device and storing data in the solid-state memory device with the data storage device.

5. The invention of claim 4, wherein (c) comprises with the host device reading the data stored by the data storage device using the program code.

6. A solid-state memory device comprising:
a first portion storing program code; and
a second portion;
wherein the program code is operative to enable a host device connected with the solid-state memory device to perform at least one of the following acts: read data stored in the second portion of the solid-state memory device using the program code or store data in the second portion of the solid-state memory device using the program code.

7. The invention of claim 6, wherein the program code is operative to enable a host device connected with the solid-state memory device to store data in the second portion of the solid-state memory device using the program code.

8. The invention of claim 1 or 6, wherein the program code is written in a hardware-independent language.

9. The invention of claim 8, wherein the hardware-independent language comprises Java.

10. The invention of claim 1 or 6, wherein the solid-state memory device comprises a first partition and a second partition, wherein the program code is stored in the first partition, and wherein data read or stored by the program code is read or stored, respectively, in the second partition.

11. The invention of claim 10, wherein the first partition is fixed.

12. The invention of claim 1 or 6, wherein the program code comprises an application selected from the group consisting of an image viewer, an audio player, a calendaring tool, a word processor, a game, and a presentation program.

13. The invention of claim 1 or 6, wherein the program code can be used only for a predetermined amount of time.

14. The invention of claim 1 or 6, wherein the program code can be used only for a predetermined number of uses.

15. The invention of claim 1 or 6, wherein the program code is operative to store data only in the solid-state memory device.

16. The invention of claim 1 or 6, wherein the program code is encrypted with an identifier of the solid-state memory device.

17. The invention of claim 1 or 6, wherein the solid-state memory device comprises a three-dimensional memory array.

18. The invention of claim 17, wherein the memory array comprises memory cells of a semiconductor material.

19. The invention of claim 17, wherein the memory array comprises write-once memory cells.

20. A method for using a solid-state memory device storing program code, the method comprising:
(a) connecting a solid-state memory device with a host device, the solid-state memory device storing encrypted program code and an identifier associated with the solid-state memory device;
(b) providing the encrypted program code and the identifier to the host device; and
(c) with the host device, decrypting the encrypted program code using the identifier.

21. The invention of claim 20 further comprising:
(d) with the host device, performing at least one of the following acts:
(d1) reading data stored in the solid-state memory device using the decrypted program code;
(d2) storing data in the solid-state memory device using the decrypted program code.

22. The invention of claim 20, wherein (b) comprises automatically providing the encrypted program code and the identifier to the host device.

23. A solid-state memory device comprising:
a first portion storing an identifier associated with the solid-state memory device; and
a second portion storing encrypted program code that can be decrypted with a host device connected with the solid-state memory device using the stored identifier.

24. The invention of claim 23, wherein, after being decrypted, the program code is operative to enable the host device connected with the solid-state memory device to perform at least one of the following acts: read data stored in the solid-state memory device using the program code or store data in the solid-state memory device using the program code.

25. The invention of claim 20 or 23, wherein the identifier is unique to the solid-state memory device.

26. The invention of claim 20 or 23, wherein the program code is written in a hardware-independent language.

27. The invention of claim 26, wherein the hardware-independent language comprises Java.

28. The invention of claim 20 or 23, wherein the solid-state memory device comprises a first partition and a second partition, wherein the encrypted program code is stored in the first partition, and wherein data read or stored by the decrypted program code is read or stored, respectively, in the second partition.

29. The invention of claim 28, wherein the first partition is fixed.

30. The invention of claim 20 or 23, wherein the program code comprises an application selected from the group consisting of an image viewer, an audio player, a calendaring tool, a word processor, a game, and a presentation program.

31. The invention of claim 20 or 23, wherein the program code can be used only for a predetermined amount of time.

32. The invention of claim 20 or 23, wherein the program code can be used only for a predetermined number of uses.

33. The invention of claim 20 or 23, wherein the program code is operative to store data only in the solid-state memory device.

34. The invention of claim 20 or 23, wherein the solid-state memory device comprises a three-dimensional memory array.

35. The invention of claim 34, wherein the memory array comprises memory cells of a semiconductor material.

36. The invention of claim 34, wherein the memory array comprises write-once memory cells.

37. A method for using a solid-state memory device storing program code, the method comprising:
(a) connecting a solid-state memory device with a host device, the solid-state memory device storing program code;
(b) providing the program code to the host device, the program code being operative to store data only in the solid-state memory device; and
(c) with the host device, storing data in the solid-state memory device using the program code.

38. The invention of claim 37, wherein (b) comprises automatically providing the program code to the host device.

39. A solid-state memory device comprising:
a first portion storing program code; and
a second portion;
wherein the program code is operative to enable a host device connected with the solid-state memory device to store data only in the second portion of the solid-state memory device using the program code.

40. The invention of claim 37 or 39, wherein the solid-state memory device comprises a write-once memory device, whereby an amount of data than can be stored in the solid-state memory device is limited.

41. The invention of claim 37 or 39, wherein the program code is written in a hardware-independent language.

42. The invention of claim 41, wherein the hardware-independent language comprises Java.

43. The invention of claim 37 or 39, wherein the solid-state memory device comprises a first partition and a second partition, wherein the program code is stored in the first partition, and wherein data stored by the program code is stored in the second partition.

44. The invention of claim 43, wherein the first partition is fixed.

45. The invention of claim 37 or 39, wherein the program code comprises an application selected from the group consisting of an image viewer, an audio player, a calendaring tool, a word processor, a game, and a presentation program.

46. The invention of claim 37 or 39, wherein the program code can be used only for a predetermined amount of time.

47. The invention of claim 37 or 39, wherein the program code can be used only for a predetermined number of uses.

48. The invention of claim 37 or 39, wherein the program code is encrypted with an identifier of the solid-state memory device.

49. The invention of claim 37 or 39, wherein the solid-state memory device comprises a three-dimensional memory array.

50. The invention of claim 49, wherein the memory array comprises memory cells of a semiconductor material.

51. The invention of claim 49, wherein the memory array comprises write-once memory cells.

52. A method for distributing program code stored in a solid-state memory device comprising a three-dimensional array of memory cells, the method comprising:
(a) storing program code in a solid-state memory device comprising a three-dimensional array of memory cells; and
(b) distributing the solid-state memory device.

53. The invention of claim 52, wherein the program code comprises an executable software application.

54. The invention of claim 52, wherein act (a) is performed by a manufacturer of the program code.

55. The invention of claim 52, wherein (b) comprises selling the solid-state memory device to a user.

56. The invention of claim 52 further comprising:
storing the software application in an additional plurality of solid-state memory devices each comprising a respective three-dimensional array of memory cells; and
distributing the additional plurality of solid-state memory devices.

57. The invention of claim 52, wherein the memory cells are arranged in a plurality of vertically-stacked layers of memory cells.

58. The invention of claim 52, wherein each memory cell comprises exactly two terminals.

59. The invention of claim 52, wherein the three-dimensional memory array comprises a plurality of wires comprising wordlines and bitlines, and wherein each memory cell is connected to exactly two wires: the respective wordline and the respective bitline.

60. The invention of claim 52, wherein the memory cells comprise a semiconductor material.

61. The invention of claim 52, wherein the memory cells comprise write-once memory cells.

62. The invention of claim 52, wherein the program code is written in a hardware-independent language.

63. The invention of claim 62, wherein the hardware-independent language comprises Java.

64. The invention of claim 52, wherein the program code is operative to enable a host device coupled with the solid-state memory device to perform at least one of the following acts: read data stored in the solid-state memory device using the program code or store data in the solid-state memory device using the program code.

65. The invention of claim 64, wherein the solid-state memory device comprises a first partition and a second partition, wherein the program code is stored in the first partition, and wherein data read or stored by the program code is read or stored, respectively, in the second partition.

66. The invention of claim 65, wherein the first partition is fixed.

67. The invention of claim 52, wherein the program code comprises an application selected from the group consisting of an image viewer, an audio player, a calendaring tool, a word processor, a game, and a presentation program.

68. The invention of claim 52, wherein the program code can be used only for a predetermined amount of time.

69. The invention of claim 52, wherein the program code can be used only for a predetermined number of uses.

70. The invention of claim 52, wherein the program code is operative to store data only in the solid-state memory device.

71. The invention of claim 52, wherein the program code is encrypted with an identifier of the solid-state memory device.
